(19) United States
(12) Patent Application Publication
(10) Pub. No.: US 2011/0154615 A1
(43) Pub. Date: Jun. 30, 2011

(54) HINGE

(75) Inventor: WEN-BIN SHEN, Tu-Cheng (TW)

(73) Assignee: HON HAI PRECISION INDUSTRY CO., LTD., Tu-Cheng (TW)

(21) Appl. No.: 12/647,434

(22) Filed: Dec. 25, 2009

(51) Int. Cl. F16C 11/04; E05D 3/02; E05D 11/10; F16C 11/10

(52) U.S. Cl. 16/331

(57) ABSTRACT

A hinge includes a fixing bracket, a shaft fixedly mounted to the fixing bracket, a rotation bracket rotatably mounted to the shaft, an interference element mounted to the shaft and engaging with the rotation bracket, and the interference element rotatable relative to the rotation bracket, a resilient assembly mounted to the shaft; and a fastener fixed to the shaft. The shaft includes a rod and a protrusion located in one end of the rod, one end of the protrusion adjacent to the rod defines a cutout in a circumference of the protrusion, and the remaining part of the end of the protrusion forms a limiting portion. The rotation bracket includes a first combination portion. The first combination portion defines a blocking portion received in the cutout and capable of engaging with the limiting portion.

### BACKGROUND

1. Technical Field

The present disclosure relates to a hinge.

2. Description of Related Art

A collapsible device, such as a notebook computer, or a clamshell mobile phone, generally includes a base, and a cover pivotably mounted to the base via a hinge. The hinge generally includes a shaft, a fixing bracket mounted to the shaft, and a rotation bracket rotatably mounted to the shaft. The fixing bracket is mounted to the base, and the rotation bracket is mounted to the cover, making the cover rotatable relative to the base. In a process of opening the collapsible device, if the cover is opened too far, the hinge may be damaged, so the hinge generally includes a blocking mechanism to prevent this from happening. However, the blocking power of the blocking mechanism is often not enough to effectively prevent the hinge from being over rotated and damaged.

### BRIEF DESCRIPTION OF THE DRAWINGS

FIG. 1 is an exploded, isometric view of an exemplary embodiment of a hinge, the hinge including a shaft.

FIG. 2 is similar to FIG. 1, but viewed from another perspective.

FIG. 3 is an assembled, isometric view of the hinge of FIG. 1.

FIG. 4 is another exemplary embodiment of the shaft of FIG. 1.

### DETAILED DESCRIPTION

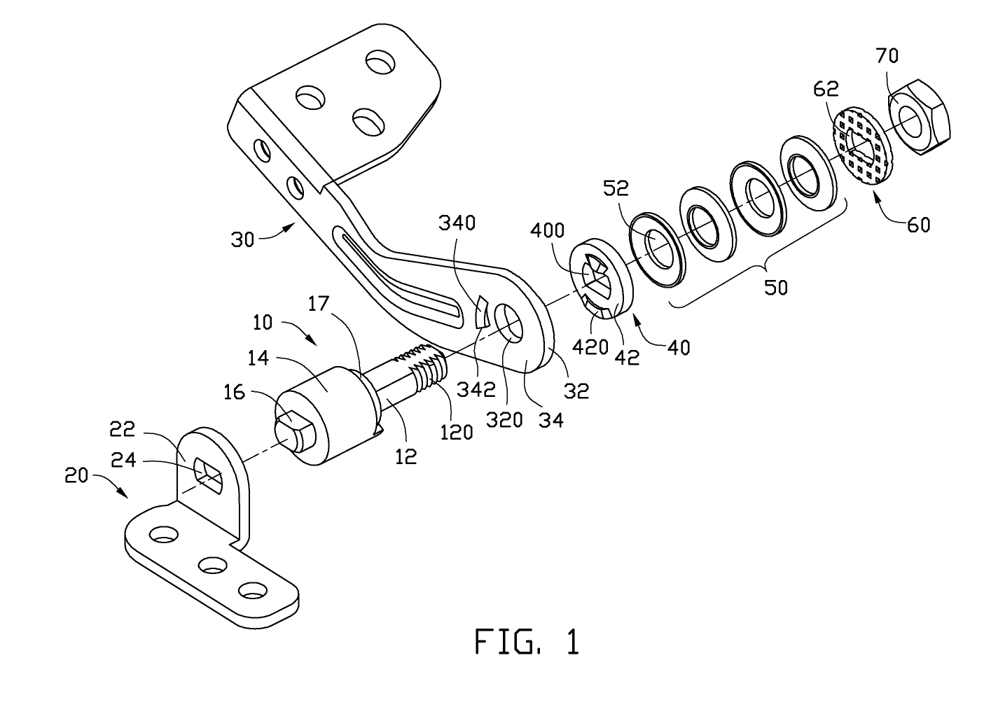

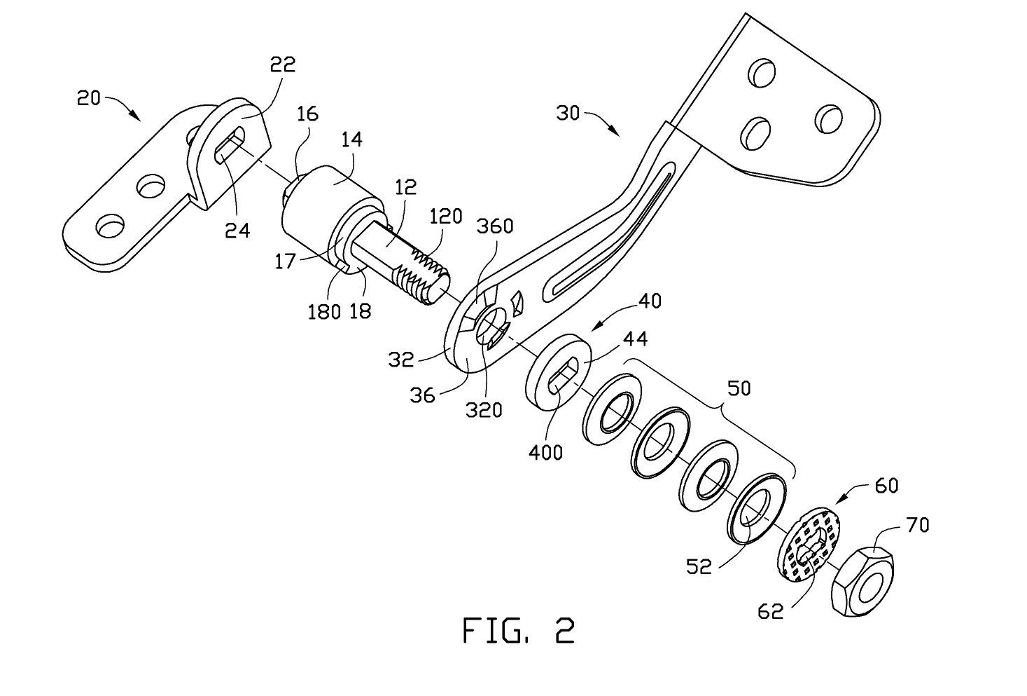

Referring to FIGS. 1 and 2, an exemplary embodiment of a hinge includes a shaft 10, a fixing bracket 20, a rotation bracket 30, an interference element 40, a resilient assembly 50, a washer 60, and a fastener 70.

The shaft 10 includes a rod 12 having a substantially double-D shaped cross-section. A first end of the rod 12 forms a threaded portion 120, and a second end of the rod 12 opposite to the first end forms a combination block 16 having a double-D shaped cross-section. A cylindrical protrusion 14 protrudes from a circumference of the rod 12, adjacent to the combination block 16. One end of the protrusion 14 adjacent to the rod 12 defines a C-shaped cutout 17 in a circumference of the protrusion 14, and the remaining part of the end of the protrusion 14 forms a limiting portion 18. Two opposite ends of the limiting portion 18 respectively form a limiting surface 180.

The fixing bracket 20 is fixed to a base of a collapsible device, such as a notebook computer, and includes a combination portion 22. The combination portion 21 defines a double-D shaped fixing hole 24 for receiving the combination block 16.

The rotation bracket 30 is fixed to a cover of the collapsible device and includes a combination portion 32. The combination portion 32 includes a first end surface 34 facing the protrusion 14, and a second surface 36 opposite to the first end surface 34. A round through hole 320 is defined in the combination portion 32, through the first end surface 34 and the second surface 36, through which the rod 12 extends. A wedge-shaped blocking portion 340 extends from the first end surface 34, neighboring the through hole 320. A first end of the blocking portion 340 is connected to the first end surface 34, and a second end of the blocking portion 340 opposite to the first end forms a blocking surface 342. The second end surface 36 defines two grooves 360 therein, around the through hole 320.

The interference element 40 can rotate relative to the rotation bracket 30 and includes a first end surface 42 facing the combination portion 32, and a second end surface 44 opposite to the first end surface 42. A double-D shaped through hole 400 is defined in a center area of the interference element 40 through the first end surface 42 and the second surface 44, through which the rod 12 extends. The first end surface 42 defines two protrusions 420 correspondingly engaging in the grooves 360.

The resilient assembly 50 includes a plurality of stacked elastic elements, each defining a through hole 52 through which the rod 12 extends.

The washer 60 defines a double-D shaped through hole 62 in a center of the washer 60, through which the rod 12 extends.

In one exemplary embodiment, the fastener 70 is a nut.

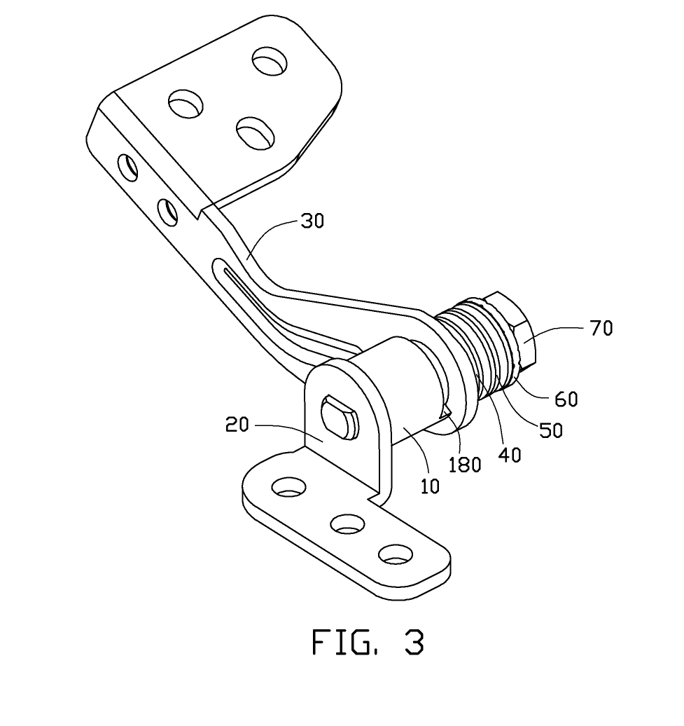

Referring to FIG. 3, during assembly, the combination block 16 is received and fixed in the fixing hole 24 of the fixing bracket 20. The rod 12 extends through the through hole 320 of the rotation bracket 30, the through hole 400 of the interference element 40, the through holes 52 of the plurality of elastic elements of the resilient assembly 50, and the through hole 62 of the washer 60 in that order. The fastener 70 engages with the threaded portion 120, fixing the fastener 70 to the shaft 10, to prevent the washer 60, the resilient assembly 50, the interference element 40, and the rotation bracket 30 from disengaging from the shaft 10. The protrusion 14 is located between the combination portion 32 and the combination portion 22. The blocking portion 340 is received in the C-shaped cutout 17.

When opening the collapsible device, the rotation bracket 30 rotates relative to the shaft 10 until the blocking surface 342 engages with one of the limiting surfaces 180, preventing further rotation of rotation bracket 30, and the collapsible device remains in a predetermined configuration. When closing the collapsible device, the rotation bracket 30 rotates relative to the shaft 10 until the protrusions 420 engage in the corresponding grooves 360, the collapsible device is closed. As the limiting portion 18 is formed on the circumference of the end of the protrusion 14, the engaging surface between the limiting portion 18 and the protrusion 14 is relatively larger thus the hinge is stronger and better able to prevent over rotation of components connected together by the hinge.

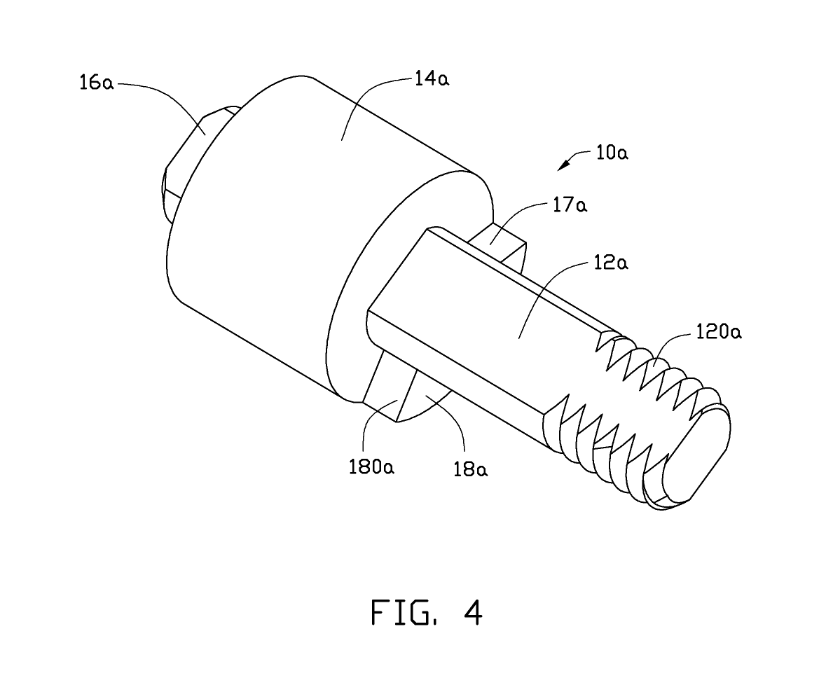

Referring to FIG. 4, in another exemplary embodiment, the shaft 10a includes a rod 12a having a substantially double-D shaped cross-section. A first end of the rod 12a forms a threaded portion 120a, and a second end of the rod 12a opposite to the first end forms a combination block 16a. A cylindrical protrusion 14a protrudes from a circumference of the rod 12a, adjacent to the combination block 16a. One end of the protrusion 14 defines a C-shaped cutout 17a in a circumference of the protrusion 14a, and the remaining part of the end of the protrusion 14a forms a limiting portion 18a. The rod 12a is connected to a wall bounding the C-shaped cutout 17a. Two opposite ends of the limiting portion 18 respectively form a limiting surface 180.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

1. A hinge comprising:
a fixing bracket;
a shaft fixedly mounted to the fixing bracket, wherein the shaft comprises a rod and a protrusion protruding from a circumference of the rod, and a limiting portion integrally formed at one end wall of the protrusion and surrounding the rod, a cutout is defined beside the limiting portion;
a rotation bracket rotatably mounted to the shaft, wherein the rotation bracket comprises a blocking portion protruding from a first surface thereof and received in the cutout to engage with the limiting portion;
an interference element mounted to the shaft, rotatable relative to the rotation bracket and engaging with a second surface of the rotation bracket opposite to the first surface;
a resilient assembly mounted to the shaft; and
a fastener fixed to the shaft.

2. The hinge of claim 1, wherein the rotation bracket comprises a first combination portion, the first combination portion defines a through hole through which the rod extends, and the blocking portion of the shaft is adjacent to the through hole.

3. The hinge of claim 1, wherein two opposite ends of the limiting portion beside the cutout respectively form a limiting surface, and the blocking portion is wedge-shaped, one end of the blocking portion forms a blocking surface to engage with the limiting surface of the limiting portion.

4. The hinge of claim 1, wherein the fixing bracket comprises a second combination portion, the second combination portion of the fixing bracket defines a fixing hole, and a combination block is formed on the other end wall of the protrusion opposite to the rod of the shaft, engaging in the fixing hole of the fixing bracket.

5. The hinge of claim 1, wherein a distal end of the rod opposite to the protrusion forms a threaded portion, the fastener is a nut engaging with the threaded portion.

6. The hinge of claim 1, wherein the resilient assembly comprises a plurality of stacked elastic elements, and each of the plurality of elastic elements defines a through hole through which the rod of the shaft extends.

7. The hinge of claim 1, wherein the second surface of the rotation bracket defines two grooves, and two protrusions extend from the interference element to correspondingly engage in the grooves.
